(19) United States
(12) Patent Application Publication
(10) Pub. No.: US 2012/0213106 A1
(43) Pub. Date: Aug. 23, 2012

(54) INTERCONNECTED RADIO NETWORK

(76) Inventor: Franz Boehm, Unterrabnitz (AT)

(21) Appl. No.: 13/395,907

(22) PCT Filed: Sep. 14, 2010
(86) PCT No.: PCT/EP10/63445

§ 371 Date: May 3, 2012

(30) Foreign Application Priority Data
Sep. 15, 2009 (AT) A 1461/2009

(51) Int. Cl. H04L 12/46; H04W 24/00; H04W 84/18; H04L 12/26

(52) U.S. Cl. 370/252; 370/255

(57) ABSTRACT

A method for establishing and operating a wireless, packet switching data transmission network can be performed by a network in which: an omnidirectional module sends request information containing the station number of a first radio station to other radio stations in the range of reception thereof after having switched on said first radio station, and in which the radio stations receiving the request information send response information containing their respective station numbers to the first radio station, and in which the first radio station sends connection requests to those radio stations from which it has received response information, and in which the first radio station uses its directional radio module to establish a directional radio link for transmitting data packets in the mesh network to the directional radio module of at least one second radio station which has responded positively to the connection request.

The present invention relates to a procedure for the configuration and operation of a wireless, packet switching data transmission network for fixed telecommunications, based on a mesh network of identically structured radio stations, each of which is assigned a unique station number.

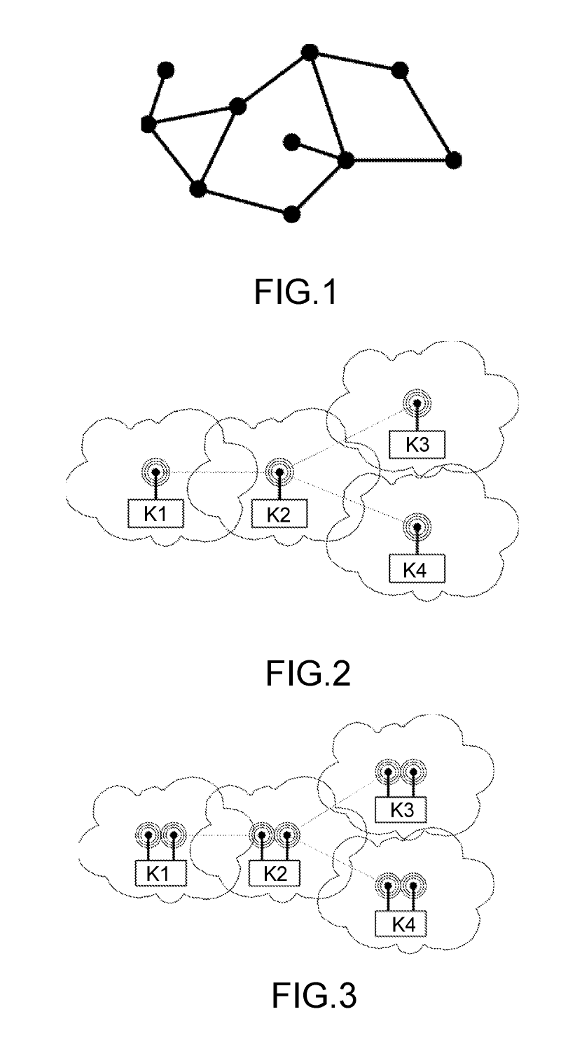

Mesh networks are known to those of skill in the art of communications technology, for example from WO 2008/150521 A1, with said networks being based on the following theory. Mesh networks allow for establishing a decentralized and fail-safe network among nodes (devices). In a mesh network, each of the sending and receiving stations and each of the nodes K1 to K4 are connected to several others, as, for example, shown in FIG. 1. Those of skill in the art will understand a mesh network to be a network which does neither have a homogenous network topology nor a identifiable central node. The information (data packets) is transmitted from one node to the next in a mesh network, until they reach their destination. Due to the plurality of possible paths between source and destination, calculating the routes in a mesh network represents a special task.

Mesh networks are found especially when radio technology is applied, as the transmission medium “air” offers ideal conditions for contacting several peers at a time. The further description of the state of the art refers more detailed to wireless mesh networks or radio networks.

The easiest form of a mesh network is shown in FIG. 2. In this case, there is a single radio interface with an omnidirectional antenna for receiving and transmitting data packets for each of the radio stations and for each of the nodes K1 to K4. By transmitting the data packets over several stations, the overall range can be multiplied. As one radio interface can only be used for sending or transmitting at one point in time, the data transmission rate becomes significantly reduced when the number of peers increases.

A further development of a mesh network is shown in FIG. 3. In this case, each of the nodes K1 to K4 uses two radio interfaces, each with an omnidirectional antenna, for communicating with different nodes. The two radio interfaces have to use different radio frequencies in order to be able to send and receive data independently from one another. This variation leads to an increased range, and the data throughput is not reduced when the number of peers increases. As each of the peers necessarily has to select two different radio frequencies and the connected nodes have to respect this selection, the selection of the appropriate radio channel from a very limited number of available channels is very difficult, however. With an increasing number and density of peers, the management of the frequency spectrum becomes ever more difficult. The service areas of the individual radio interfaces overlap to an ever larger extent, which leads to the development of mutual interferences which can only partly be managed by an intelligent regulation of the transmitting power and, thus, by a limitation of the range. An improved assignment of the radio channels can be achieved by pseudo-random frequency hopping. This leads to a homogenous utilization of all radio channels by all stations. The more channels are available for the frequency hopping, the less probable becomes the simultaneous, in terms of time and space, usage of one channel by two nodes. Due to the arbitrary propagation of electromagnetic radiation, mesh networks with omnidirectional antennas create a hardly controllable environment, which makes it more difficult to maintain a clear communication on all connections.

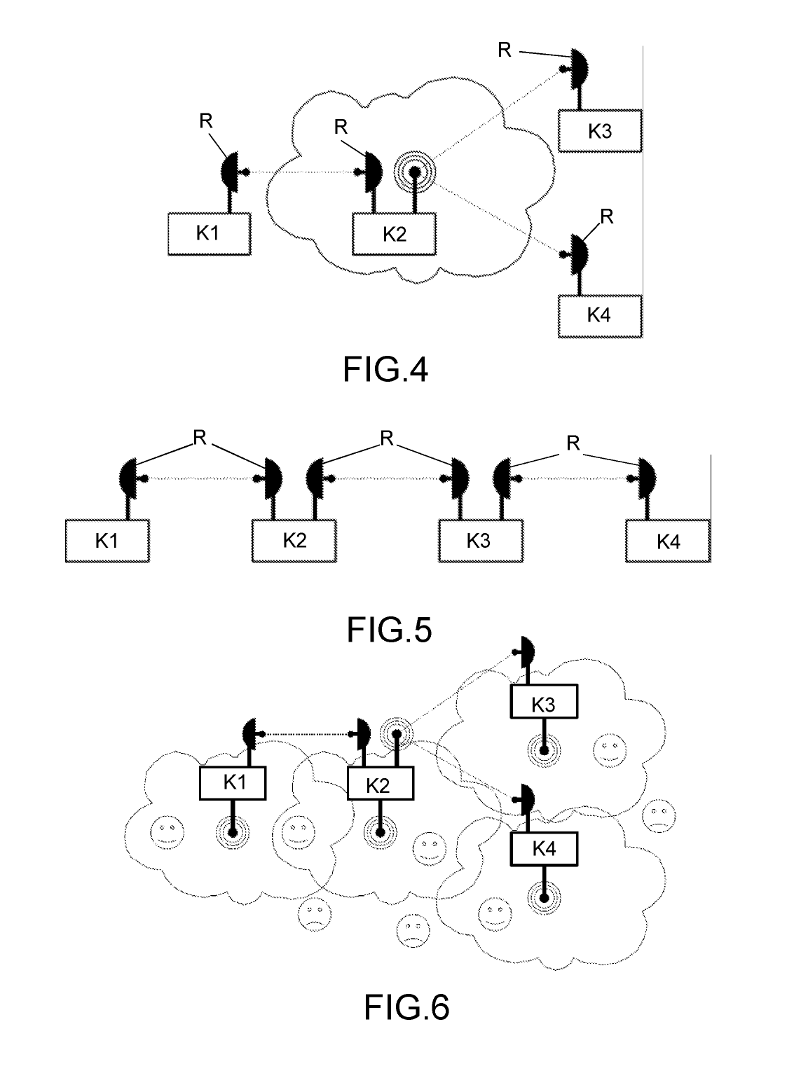

The use of sector or directional antennas instead of omnidirectional antennas allows for a significant increase of the range and/or of the data transmission rate. Such a mesh network with sector or directional antennas is shown in FIG. 4. The restricted angle of emission of the sector or directional antennas R, forces an exact orientation of the antennas and only allows for the establishment of a connection with stations located within the emission angle of the respective sector or directional antenna R.

By using directional antennas at both ends of a radio link, particularly great distances and/or data transmission rates can be achieved, as the emitted power of the transmitting antenna is focused to the receiving antenna and vice versa. In case of such a point-to-point connection, there is only direct communication between the two end points of a radio link. A network with radio stations and directional antennas R can, thus, only be established if each radio station has two directional antennas R. This way, several radio stations or nodes K1 to K4 can be connected to one another like a chain. The configuration corresponds to that of a bus topology and is shown in FIG. 5. If one link of this chain fails, the chain is divided into two parts and communication is very limited. A redundant connection of all peers is achieved when the chain is closed to form a ring.

Mesh radio networks are used for at least one of the following reasons:
Redundant connection of devices or nodes in order to achieve a higher failure safety.
Spontaneous communication among several (mostly mobile) devices due to a decentralized configuration and a dynamic calculation of possible routes.
Increasing the overall range and data transmission rate by using the packet forwarding at every node as a signal amplifier.

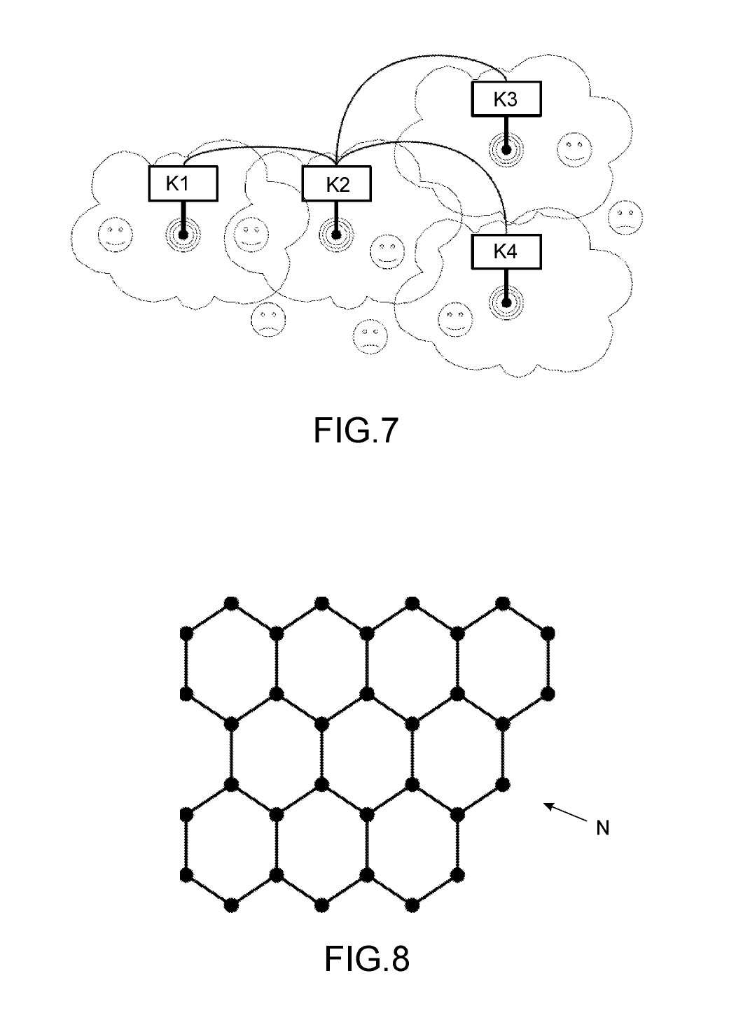

Various companies offer commercial wireless mesh data transmission systems with the aim of allowing for a large-area and continuous radio coverage area without the need of cables. These products enable devices, such as cordless phones, notebooks, data collection terminals, etc, to use mobile data transmission within the coverage area. The connection of stationary devices, such as video cameras, is also made possible. Such solutions are used for warehouses, on company premises and in public places. The functionality of these solutions is shown in FIG. 6. Redundant connections of the network nodes are less relevant in this scenario. A seamless and sufficiently fast connection of the devices is expected. In order to fulfil these requirements, the overall network topology is thoroughly planned when establishing and expanding the network, and there are practically no dynamic changes after having put the network into operation. Thus, an operation without any dynamic calculation of the routes is possible. A technically more powerful, but often very cost-intensive alternative would consist in establishing a cable connection to each network node. Like mentioned before, the nodes create with the omnidirectional antennas an extensive “radio cloud”. The cabling layout is usually star-shaped, which means that the network is no longer a mesh network. This configuration is shown in FIG. 7.

Mesh networks between buildings with the help of wireless mesh data transmission are often established by private interest groups. These groups are often organized in associations responsible for the co-ordination of the expansion of these networks. An uncoordinated expansion of such networks would lead to frequent failures and their regular functionality could not be guaranteed in the long run. Due to frequent changes and expansions of the network topology, redundant connections are especially important in this scenario in order to be able to maintain the communication between all peers in case of maintenance works or failures. The use of license-free data radio technology in combination with dynamic route calculations allows to create powerful and fail-safe networks for the internal exchange of data or for establishing a connection to the Internet.

The use of commercial products for such purposes is not known, except for some field trials. Only main connections (the backbone) of many radio Internet providers or mobile communication providers can be meshed in order to provide for a distribution of loads and to guarantee failure safety.

Devices, such as the XO-1 notebook used in the “One Laptop per Child” project, are able to autonomously establish a mesh radio network in order to establish communication among as many devices of the same kind as possible. If possible, redundant connections are established, but it is still accepted that the communication in the network is significantly impaired if a single device is turned off or changes its location. A zero configuration mesh network and a fast and automatic adaptation to changes in the network topology are especially important in this respect. The number of and the distances between the nodes can and will constantly change due to the mobility of the devices. This method still offers a unique possibility for establishing data communication among students with XO-1 notebooks in developing countries without an Internet infrastructure. The fact that only an uncertain and with an increasing number of devices decreasing data transmission rate can be expected, is consciously accepted.

It is an object of the present invention to develop a method for establishing and operating a wireless, packet switching data transmission network, avoiding the above-mentioned disadvantages of known data transmission networks. According to the invention, this object is fulfilled by providing a network in which

a. an omnidirectional module sends a request information containing the station number of a first radio station to other radio stations in the range of reception of the first radio station, after having switched on said first radio station, and in which

b. the radio stations receiving the request information send response information containing their respective station number to the first radio station, and in which

c. the first radio station sends connection requests to those radio stations from which it has received response information, and in which

d. the first radio station uses its directional radio module to establish a directional radio link for transmitting data packets in the mesh network to the directional radio module of at least one second radio station which has responded positively to the connection request.

The invention is, thus, among other things characterized by the fact that each radio station in the mesh network is provided especially with three independent directional radio modules. This way, it is possible to establish links with up to three other radio stations. Each of said directional radio links functions as a direct data transmission channel between two radio stations. As can be seen in FIG. 8, this is sufficient for theoretically being able to establish networks N of any size. The exclusive use of three point-to-point directional radio links per radio station allows for establishing a large-area network with particularly high data transmission rates among many radio stations. As a manual adjustment of directional antennas to the desired counterpart becomes ever more difficult with an increasing number of peers, the directional antennas are provided with an electromechanical drive which allows for pivoting them in a horizontal plane. Further optimization is possible by electromechanically adjusting the antenna in the vertical plane and in the polarization plane. This configuration is particularly powerful as point-to-point radio links can be configured using particularly simple and efficient radio transmission protocols, where only two communication participants have to co-ordinate their transmission times. If a sufficiently large frequency spectrum is available, all point-to-point radio links can be provided as particularly powerful full-duplex links having separate transmitting and receiving paths. Usually, dual polarized directional antennas are used in this case, in order to be able to simultaneously transmit and receive data using a single directional antenna. With an increasing number and density of radio stations in such a configuration, the network becomes ever more closely meshed, where the average directional radio links becoming ever shorter and, thus, more powerful. With an increasing number of peers in a network, there is an increasing probability that a new peer will find a communication partner which is sufficiently close. Radio stations at the periphery of a mesh network can also establish links to radio stations at the opposite end of the network, if they are still within their radio range. This leads to an additional reduction of the average path lengths between the radio stations. Other advantageous variations of the method of the invention will be described below, referring to the figures.

FIG. 1 shows a symbolic representation of a mesh radio network according to the state of the art.

FIG. 2 shows a part of another mesh radio network according to the state of the art.

FIG. 3 shows a part of a further developed form of a mesh radio network according to the state of the art.

FIG. 4 shows a part of another mesh radio network according to the state of the art.

FIG. 5 shows a radio network according to the state of the art, with directional antennas arranged in a chain.

FIG. 6 shows a part of another mesh radio network according to the state of the art, with directional antennas for establishing a network among mobile devices.

FIG. 7 shows a radio network with a star-shaped cable connection for linking mobile devices according to the state of the art.

FIG. 8 shows a part of a homogeneously configured, mesh network of the invention.

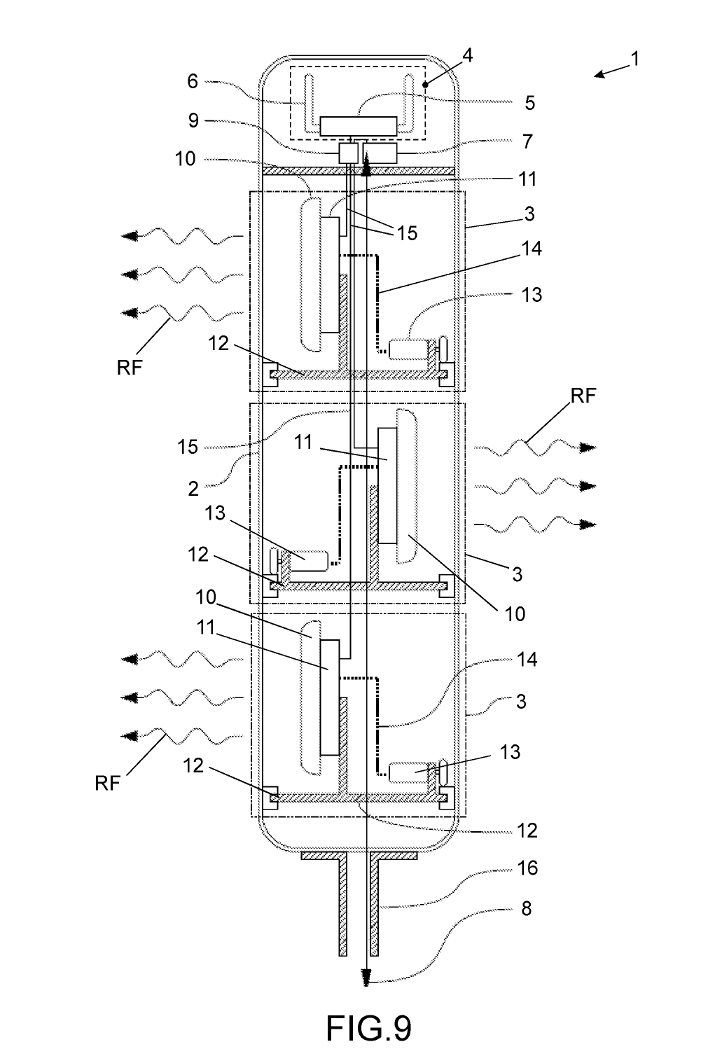

FIG. 9 shows the mechanical construction of a radio station of the invention.

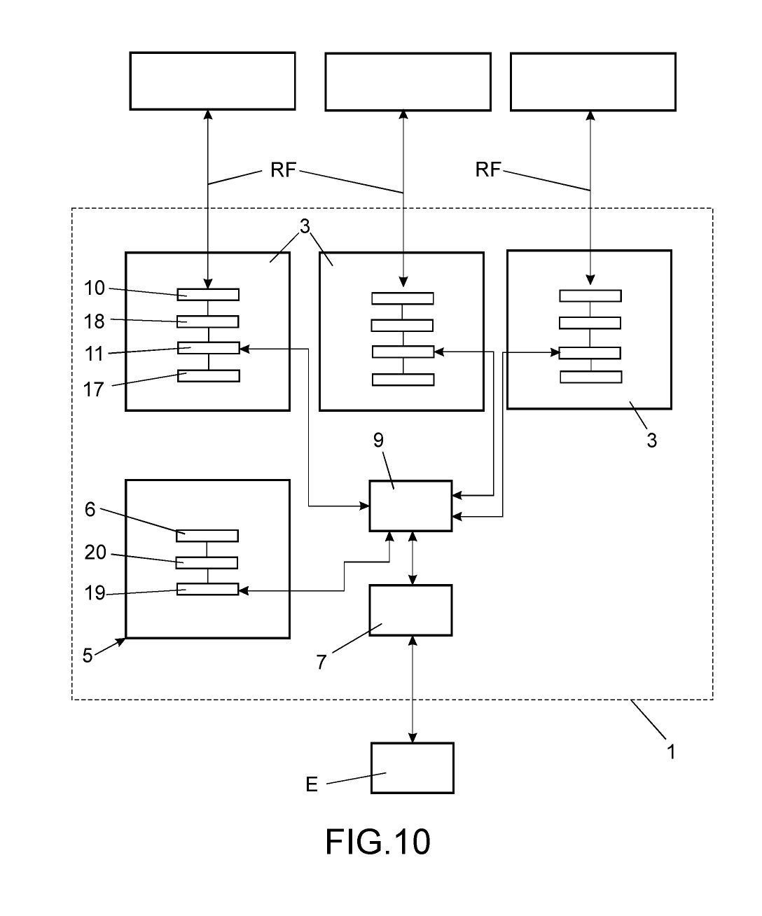

FIG. 10 shows the functional configuration of a radio station of FIG. 9.

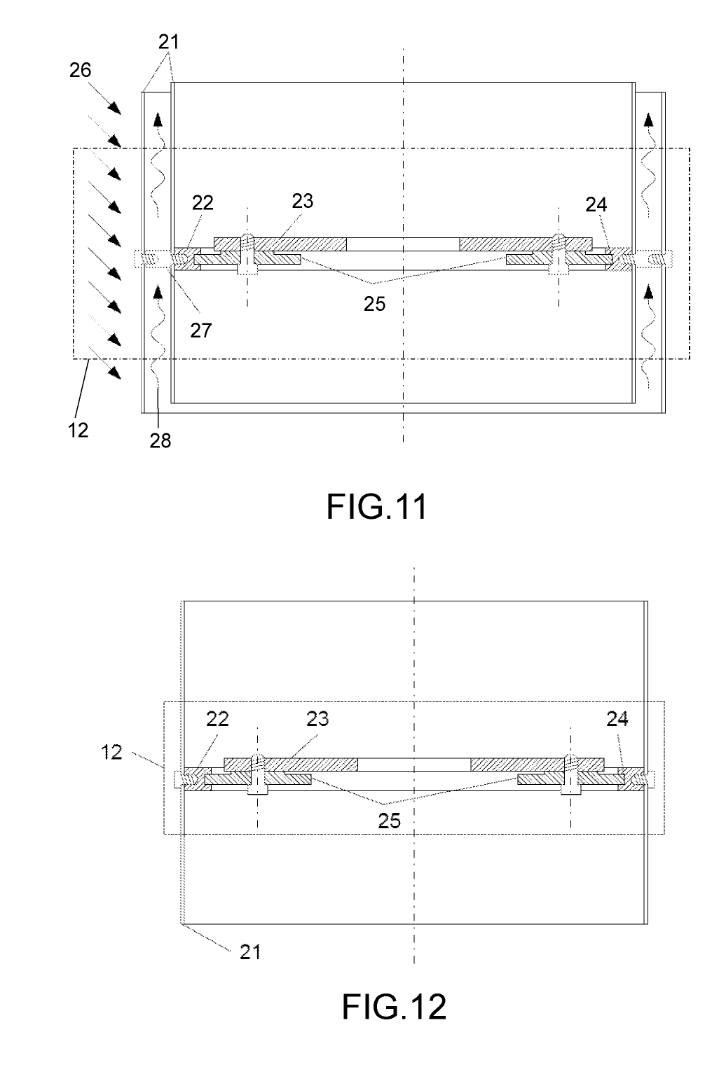

FIG. 11 shows a detailed view of the construction of a housing and of the pivoted antenna support in cross-section.

FIG. 12 shows an alternative embodiment of a housing having a one-walled plastic cover.

FIG. 9 shows a radio installation or a radio station 1 which is mounted above (on the roof) the objects (buildings, containers, tents, etc) among which a network is to be established and which allows for the fast and cost-efficient establishment of a universal, powerful and fail-safe telecommunications system. The mesh network of the invention fulfils all the requirements for being used as “last mile” technology (for covering the last link sections to the customers) for providing entire communities with a high-quality Internet, telephone and TV supply. Moreover, it is possible to establish networks on extensive premises of companies and events and to establish a data transmission infrastructure for crisis and disaster operations within a very short time.

The mechanical construction of the radio station is shown in FIG. 9, while its functional configuration is represented in FIG. 10. The radio station 1 consists of a covering plastic dome 2 in which three directional radio modules 3, one omnidirectional module 4 having a locating module 5 for position determination and an omnidirectional antenna 6, one termination module 7 for connecting a connection line 8 to a device E, and a splitter 9 for establishing an internal connection of all modules are arranged. Each directional radio module 3 provides a radio interface for communicating with a directional radio module of another radio station and has a directional radio module-cable interface for the internal communication with all the other components of the radio station 1.

The directional radio modules 3 each consist of a unidirectional antenna 10 and a data processing unit 11, including transmitting and receiving electronics (high-frequency electronics) for the de-/modulation of the radio signal as well as a pivot-mounted antenna support 12 having an electromechanical drive 13 for adjusting the directional antenna 10 to another radio station. The drive 13 is connected to the data processing unit 11 via a control line 14, said data processing unit 11 being connected to the splitter 9 via a data line 15. The radio station 1 can be placed on and fixed to a previously mounted antenna mast. The directional radio module-cable interface is implemented as part of the data processing unit 11. Each radio station which is to be integrated into the mesh network N is assigned a unique station number before being put into operation. After having been turned on, the radio station automatically starts searching for neighbouring radio stations within its range of reception by means of the locating module 5. This is done by sending its own station number in a request information via an omnidirectional antenna 6. All radio stations within its range of reception will respond with their station number and the signal strength at which the request information was received. If the searching radio station 1 receives information in response to its request information, the signal strength of the response information will be recorded. Thus, the searching radio station 1 will have a list of all radio stations within its range of reception and the respective connection qualities in both directions at its disposition. Based on this information, the best suited communication partners will be selected and connection requests will be sent to them, one after the other, until one of them agrees to establish a connection. By applying this “trial and error” principle, all radio stations will be able to establish a mesh network, without any external intervention, said network providing short and, thus, powerful point-to-point radio links.

In order to accelerate the establishment of a connection after a power outage, each radio station can write the required information into a non-volatile memory, in order to be able to re-establish the original connections without having to carry out another search for stations. Moreover, radio stations can use accumulators for remaining in operation for a limited period of time during a power outage, in order to be able to make emergency calls using a stationary telephone connected to said radio station.

After the radio station 1 has reached an agreement concerning the establishment of a connection with another radio station within the radio range of the omnidirectional module, the establishment of a directional radio link is initiated; both stations determine an available directional radio module 3 for said directional radio link to the other radio station. The connection is established by rotating a first directional antenna 10 of the directional radio module 3 in a horizontal plane clockwise and counter-clockwise around its own axis, until a reference signal of the opposite locating module 5 is received. The rotation of the first directional antenna 10 in the horizontal plane is stopped, after the reference signal has been received at maximum strength and quality. The first directional antenna 10 is then rotated in a vertical plane and counter-clockwise, until the signal strength and quality have reached a maximum value. The same process is repeated for adjusting the second directional antenna of the other radio station, until the second directional antenna 10 receives the reference signal of the locating module 5 or of the first directional antenna 10 of the first radio station at a maximum strength and quality. After that, a radio link is established via the two adjusted directional antennas by determining a radio channel which is as interference-free as possible and by agreeing on a data encryption. Based on current requirements, the two directional radio modules 3 continuously regulate the data transmission rate and the transmitting power to as low as possible, so that the radio channel which they use can also be used for other directional radio links already at a short distance. Due to this process, relatively few radio channels which do not overlap will be sufficient for establishing a network of any size. If no data traffic is to be expected, a directional radio link can also be switched into an energy-saving standby state with particularly low transmitting power. By measuring the delay time until a data packet reaches the neighbouring radio stations, it is possible for the station to determine its own relative position within the overall network.

After having established a stable directional radio link, the two involved radio stations communicate this change of the network topology to the immediately neighbouring stations. When a radio station receives such a message, it has to examine whether this results in the creation of connections to new destinations or shorter connections to known destinations. If this is the case, the stations' own routing tables have to be changed and messages have to be sent to the radio stations directly connected to them. If a directional radio link is interrupted, this also has to be communicated to immediately neighbouring stations, which will then, in turn, examine their routing tables for necessary changes. This way, all radio stations receive the necessary information for being able to establish complete and correct routing tables.

The establishment of a link between the radio stations takes place autonomously and can be monitored by an optional controlling system, in order to determine and indicate failures. It is, however, still possible to suppress or enforce certain connections by means of a corresponding configuration of the radio stations—for example, in order to permanently avoid the establishment of an undesired connection or of connections which are liable to fail.

Each radio station tries to establish links to two other radio stations, in order to prevent several radio stations from becoming unreachable if one single radio station fails. If a radio station cannot find any communication partner within its range, another search will be conducted after a determined or random period of time. In this case, it can be helpful to put a so called “support station” into temporary or permanent operation. The construction and functions of said support station correspond to those of a radio station 1; there are, however, no devices connected to the termination module 7.

In FIG. 10, the functional configuration of the radio station 1 is represented again according to its functional blocks. Data to be transmitted are sent from the device E via the termination module 7, the splitter 9, and one of the directional radio modules 3 over a directional radio link RF to a directional radio module of another radio station. Each directional radio module 3 has electronics 17 for adjusting the antenna which comprises a pivot-mounted antenna support 12 with an electro mechanic drive 13. Moreover, each directional radio module 3 has a data processing unit 11, radio frequency electronics 18, and a unidirectional antenna 10. The locating module 5 for determining positions includes a data processing unit 19, radio frequency electronics 20, and an omnidirectional antenna 6.

Usually, the wireless mesh network N will be linked to a superior network, such as a company network, the provider backbone, or the Internet. It is, however, also possible to operate said network N without any superior network. The connection to said superior network is established via one or several feeding points or stations at favourable locations. The configuration and functions of these feeding points correspond to those of the radio station 1; there is, however, no device connected to the termination module 7, but said module 7 is used to establish a connection to the superior network. The only difference between the feeding station and a normal radio station consists in the fact that feeding stations will identify themselves as feeding stations when a search is conducted, as they are particularly preferred partners for radio stations. If a single feeding station is not sufficient, for providing the required data transmission rate between a superior network and the mesh network, further feeding stations can be put into operation at any point in the network and, thus, the data transmission rate from and to the superior network will be multiplied. Moreover, the use of a plurality of feeding stations allows for establishing redundant connections to the superior network. If a device establishes a connection to the external network, the data traffic will automatically be handled by the closest feeding station.

Based on addresses and labels contained in the incoming data packets, the data processing unit 1 in the directional radio module 3 decides whether they will be transmitted via the splitter 9 to another directional radio module 3 or via the termination module 7 and the connection 8 to the local devices E. To this end, each directional radio module 3 manages a table assigning destination addresses to interfaces (routing table). This configuration has the advantage that each directional radio module 3 does not have to process all received data packets, but only those which are received at the radio interface and transmitted via the directional radio module-cable interface. No decision concerning the further transmission of the packets has to be made for any data packet received via the directional radio module-cable interface of a directional radio module 3. These data packets always have to be transmitted via the radio interface. This makes it possible that each directional radio module 3 only has to process parts of the overall data traffic of a radio station. This allows for a high overall data transmission performance within a radio station without using particularly powerful and cost-intensive processors for centralized processing of the overall data traffic. Moreover, the electric power loss will be distributed from one central data processing unit to three smaller ones. Thus, there is no need for sophisticated cooling equipment.

If data packets are fed into the radio network by a device E via the termination module 7, it will be decided based on the routing table via which directional radio module 3 the data will be transmitted. Before the transfer of certain data packets, a virtual connection to the destination can be prepared, by informing all the radio stations involved about the upcoming data traffic. This is done by determining an identification number which is communicated to all the radio stations involved. Optionally, transmission capacities along the entire path can be reserved. The radio stations involved know how to treat data packets having a certain identification number. All the relevant data packets are provided with a label containing the identification number when entering the radio network at the termination module 7. The data packets are then transmitted from one radio station to the next along a determined path until reaching their destination. Before leaving the radio network, the termination module 7 at the destination location will remove the label from each data packet. If several destinations are indicated when establishing a virtual connection, data packets can be duplicated in radio stations and transmitted in parallel via two directional radio modules 3. Thus, it is possible to efficiently transmit data packets to several or all radio stations at the same time.

FIG. 11 shows a detailed cross-sectional view of the construction of the housing of the directional radio module 3 of the radio station 1 and, particularly, of the pivot-mounted antenna support 12. This construction allows for an independent rotation of the directional radio module 3 around its own axis and, thus, for an adjustment of each directional radio module 3 to any direction.

This is made possible by a construction in which there is no interior supporting structure (“antenna mast”), creating some free space at the centre of the housing in order to allow for establishing a flexible cable connection between the electronic modules which are arranged one above the other. The mechanical stability of the overall housing is guaranteed by a frictional connection of the enclosing plastic cover 21 by means of interior rings 22. The ring 22 serves both the purpose of stiffening the plastic cover 21 and the purpose of providing a rotary support for an antenna support plate 23. To this end, the ring 22 has an interior, circumferential guiding notch 24. This guiding notch 24 has a gearing, so that the ring 22 forms an internally toothed gear ring. It can be noted that the guiding notch 24 may also be implemented without a gearing.

Within the ring 22, the antenna support plate 23 is arranged, said plate being movably connected to the enclosing ring 22 at least three points, so that said antenna support plate 23 is held at the centre of the ring 22, while allowing for its rotation at the same time. These connection points are implemented in the form of geared and/or smooth wheels 25 or as sliding connections.

The rotary movement is electronically driven by at least one DC motor, stepper motor, or piezoelectric motor (ultrasonic motor) by coupling a motor shaft, which is not represented in FIG. 11, via additional gear parts to at least one of the wheels 25. The rotation movement can also be brought about by means of directly transmitting a wave-like movement of at least one piezoelectric ceramic element mounted to the antenna support plate 23 to a running path mounted to the interior side of the ring 22.

By mounting at least one micro switch, light barrier, or magnetic switch to the antenna support plate 23, marks on the ring 22 or one of the wheels 25 can be identified and electronically evaluated. These marks provide information on the current angle of rotation of the antenna 10 on the antenna support plate 23 to the electronics 17, which makes it possible to rotate the antenna support 12 into a defined initial position and to determine when the support has completed a full rotation. By means of two neighbouring sensors mounted to the antenna support 12, regular marks along the entire circumference of the ring 22 or one of the wheels 25 can be used for determining the direction, angle, and velocity of the current rotation process.

This construction of the antenna support 12 provides the advantage that the three antennas 10 can be rotated around their axes independently from one another.

The plastic cover 21 can be two-walled in order to reduce the thermal influence of direct sunlight 26. To this end, spacers 27 are provided for forming a hollow space between the internal and the external cover 1 in order to allow the heated air 28 to escape upwards. Both the internal and the external cover can be provided with a heat insulating layer of foamed plastic.

FIG. 12 shows an alternative embodiment of the housing having a plastic cover 21 with a single wall.

1. A method for establishing and operating a wireless, packet switching data transmission network for stationary telecommunication purposes based on a mesh network of identically constructed radio stations, each of which is marked by a unique station number, the method comprising:
a. an omnidirectional module sending request information containing the station number of a first radio station to other radio stations in the range of reception of said first radio station, after having switched on said first radio station;
b. the other radio stations receiving the request information and sending response information containing their respective station numbers to the first radio station;
c. the first radio station sending connection requests to those radio stations from which it has received response information; and
d. the first radio station using its directional radio module to establish a directional radio link for transmitting data packets in the mesh network to the directional radio module of at least one second radio station which has responded positively to the connection request.

2. The method according to claim 1, wherein establishment of the directional radio link comprises the following steps:
the first radio station moving a first directional antenna, which is driven to rotate in a horizontal plane, of the directional radio module clockwise or counter-clockwise until the first directional antenna receives a reference signal emitted by the omnidirectional module of the second radio station and/or a second directional antenna of the second radio station;
the second radio station moving a second directional antenna, which is driven to rotate within a horizontal plane, of the second directional radio module clockwise or counter-clockwise until the second directional antenna receives a reference signal emitted by the omnidirectional module of the first radio station and/or the first directional antenna of the first radio station while establishing the directional radio link; and
transmitting and receiving a data packet via the adjusted first directional antenna and second directional antenna in order to test the directional radio link.

3. The method according to claim 2, wherein the first directional antenna and/or the second directional antenna is/are adjusted horizontally, vertically and/or in their polarization planes, until the reference signal of the opposite radio station is received at a maximum signal strength and signal quality.

4. The method according to claim 1, comprising:
the radio stations receiving the request information from the first radio station measuring the signal strength and the signal quality of the received request information and sending the measured signal strength and the measured signal quality back to the first radio station in the response information; and
the first radio station measuring the signal strength and the signal quality of the response information and sending connection requests to those radio stations whose measured signal strength and signal quality contained in the response information and/or whose signal strength and signal quality of the response information measured by the first radio station are strong compared to the other measured signal strengths and signal qualities of the other radio stations.

5. The method according to claim 1, comprising:
the first radio station determining the distance between said first radio station and another radio station by measuring the delay time of a data packet which is transmitted to and received by said other radio station and sending connection requests to those radio stations which, compared to other radio stations, are closer to the first radio station.

6. The method according to claim 1, comprising:
the first radio station having at least two independent directional radio modules establishing a directional radio link to at least two other radio stations located within the radio range of the omnidirectional module in order to establish the mesh network.

7. The method according to claim 1, wherein data packets received by the radio station via the directional radio link are further transmitted according to a label contained in each data packet, either over another directional radio link of the radio station via radio or over a cable interface of the radio station via a cable connection.

8. The method according to claim 7, wherein each directional radio module of the radio station autonomously decides about the further distribution of the data packets received over the directional antenna according to the labels contained in the data packets.

9. The method according to claim 1, wherein each directional radio module further transmits all data packets received over a directional radio module-cable interface of the directional radio module via the directional antenna without any further processing.

10. The method according to claim 1, comprising:
adding a label to each of the data packets transmitted over a cable interface to the radio station, said label containing information concerning the further transmission of the data packet within the mesh network, before the data packets are transmitted over the directional radio links of the radio stations.

11. The method according to claim 1, wherein the radio stations are able to multiply data packets by transmitting them simultaneously via several directional radio links and/or via a cable interface.

12. The method according to claim 1, wherein establishment or disestablishment of a directional radio link between two radio stations is communicated to all radio stations connected to said two radio stations via other directional radio links.

13. The method according to claim 12, comprising:
passing information concerning the establishment or disestablishment of directional radio links on from each radio station to other radio stations until this information reaches relevant radio stations within the radio network.

14. The method according to claim 1, wherein two radio stations are forced to establish or prevented from establishing a directional radio link between one another by means of the configuration of the respective radio stations.

15. The method according to claim 1, wherein the first directional radio module sends the request information to the radio station within the radio range of the first radio station and the first directional radio module receives the response information from the radio stations responding to said request information.

16. A radio station for implementing the method according to claim 1, comprising:
an omnidirectional module comprising at least one omnidirectional antenna for transmitting request information and connection requests to omnidirectional modules of other radio stations and for receiving response information from radio stations located within the radio range of said radio station;
at least two independent directional radio modules configured for establishing two directional radio links to two other radio stations in order to transmit data packets within the mesh network, each directional radio module having a motor for driving a directional antenna to rotate within a horizontal plane and in a vertical plane and/or the polarization plane; and
a cable interface for coupling data packets from a cable into the wireless mesh network or for decoupling data packets from the wireless mesh network.
